(19) United States
(12) Patent Application Publication
(10) Pub. No.: US 2015/0048151 A1
(43) Pub. Date: Feb. 19, 2015

(54) Tamper Resistant Carton

(71) Applicant: Hub Folding Box Company, Mansfield, MA (US)

(72) Inventor: Byron C Brandow, Marion, MA (US)

(21) Appl. No.: 14/459,294

(22) Filed: Aug. 13, 2014

Related U.S. Application Data
(60) Provisional application No. 61/865,355, filed on Aug. 13, 2013.

(51) Int. Cl. B65D 5/02; B31B 1/62; B65D 55/02

(52) U.S. Cl. CPC B65D 5/0227; B65D 55/026; B31B 1/62
USPC 229/182; 493/128

(57) ABSTRACT

Disclosed is a tear-resistant folding carton comprising a paperboard unit, the unit comprising a paperboard layer, an upper film layer laminated to an upper side of the paperboard layer and a lower film layer laminated to a lower side of the paperboard layer, the carton comprising joining areas in which one portion of the unit overlaps and is joined to a second portion of the unit. Also disclosed is a method of making such a carton.

### TECHNICAL FIELD

This invention relates to product packaging and more particularly to tear-resistant or tamper-resistant packaging for consumer products, particularly value-added products that are prone to shop-lifting.

### BACKGROUND

U.S. Provisional Patent Application 61/829,080 filed on May 30, 2013 is hereby incorporated by reference in its entirety.

In order to deter in-store destruction of packaging, a common practice has been to increase the amount and placement of adhesive in order to add increased evidence of fiber tear on the paperboard closing carton flaps, thereby alerting the consumer that the package has been previously opened. U.S. Pat. No. 6,070,790, issued to Colgate-Palmolive, addresses such issues, but does not address methods to prevent items being removed from packaging, and therefore should not be confused with packaging which provides tear resistance.

Another common practice has been to design packaging with interlocking flaps whereby the carton cannot be opened except by tearing a portion of the carton (U.S. Pat. No. 3,462,066 issued to Reynolds Metals). Although this design is a theft deterrent, it still allows for the paperboard substrate to be torn open.

Another common practice to prevent in-store theft has been to remove the product from the store shelf and place it behind the counter in a secure area. Lack of shelf presence can adversely affect product sales.

Another common practice has been to lock the package in a clear plastic container. The consumer needs to take the container to the store clerk, have it unlocked, and then purchase the item. This process is not consumer friendly, is time consuming and adds additional costs associated with each sale.

Another common practice to prevent theft is attaching a tracking device, such as an RFID chip, to the package. If the thief tries leaving the store an alarm is sounded. This preventative measure does not work if the item is removed from the package, the packaging is left on the shelf and the item is concealed in clothing or a handbag.

U.S. Pat. No. 7,051,876 issued to Colbert Packaging discloses clamshell packaging for displaying and housing products. The packaging includes a tear-resistant housing that encloses a display chamber. Tear resistance is achieved by adhering an oriented cross grain laminated film or other substrates with cross-grain properties on a single side of a paperboard substrate to provide cut or tear resistance in multiple directions. This patent does not, however, address what is commonly referred to as a folding carton style package.

There is a need for a folding carton style package which will have tear resistance strong enough to alert store clerks and consumers that a thief is removing an item from the carton in order to conceal it in clothing or a handbag. Chances of in-store theft may be drastically reduced if it becomes apparent that a thief is noticeably struggling to open the package in order to remove the item.

### SUMMARY

In one aspect the invention generally features a tamper-resistant folding carton having a cut and scored paperboard blank folded and joined, (e.g., glued at joining areas) in a manner which does not allow for easy access to the package product. In addition the paperboard carton blank has a layer of film (preferably tear resistant polymer film) laminated to the top side of the paperboard surface and a layer of film (also preferably tear resistant polymer film) laminated to the bottom side of the paperboard. These film layers will accept adhesive as a method of sealing portions of the carton to itself. In addition the upper and lower film layers provide the ability to seal portions of the carton to itself using sealing methods such as heat and pressure, infrared, ultrasonic, ultraviolet and radio frequency energy.

The paperboard layer preferably is a paperboard base stock between 0.006 and 0.040 inches thick and can be identified as Solid Bleached Sulphate (SBS), Solid Unbleached Sulphate (SUS), and Clay Coated News (CCN).

The laminated film may be linear low density polyethylene, low density polyethylene, medium density polyethylene, high density polyethylene, polypropylene and polyethylene terephthalate. The film is either non-oriented or oriented film. If it is oriented, the orientation of the upper film layers is substantially the same as the orientation of the lower film layers.

Areas of the carton where flaps or panels that are single thickness—i.e., they are not adhered to other flaps or panels—exhibit a machined direction (MD) tear resistance of at least 520, and a cross direction (CD) tear resistance of at least 570, measured by TAPPI Test Method T414, Internal Tearing Resistance of Paper and expressed in units of gram force. Joining areas of the carton where flaps or panels are multilayered—i.e., they are joined or adhered to other flaps or panels—exhibit a MD tear resistance of at least 1600, and a CD tear resistance of at least 1700. In general a preferred method is to seal as many flaps or panels to other portions of the carton to create two plies in which the overall tear resistance as described above (assuming two plies) is at least 1600 in the machine direction and 1700 in the cross direction. More preferably the tear resistance under these conditions is at least 1700 in the machine direction and 1900 in the cross direction.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a flat blank design for a tear resistant tri-sealed folding carton.

FIG. 2 shows an enlarged cross-section of the blank design of FIG. 1, taken along 1-1 of FIG. 1.

FIG. 3 shows a tri-sealed carton showing an application of adhesive to dust flaps.

FIG. 4 shows forming a tri-seal carton with additional adhesive applied to various locations.

FIG. 5 shows a completely formed and sealed tri-seal carton.

FIG. 6 shows a flat blank design for a tear resistant gabled display folding carton.

FIG. 7 shows a gabled display folding carton with adhesive.

FIG. 8 shows a completely formed and sealed gabled display folding carton.

Like reference symbols in the various drawings indicate like elements.

### DETAILED DESCRIPTION

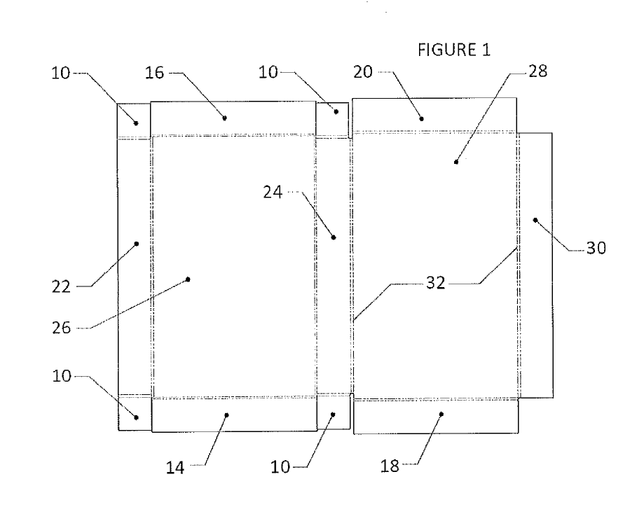

FIG. 1 shows a flat blank design for a tear resistant tri-sealed folding carton with score lines 32 and die cut areas identified as bottom closure minor panel 14, top closure minor panel 16, bottom closure major panel 18, top closure major panel 20, dust flaps 10, a glue flap 22, a rear panel 26, a front panel 28, a left side panel 30 and a right side panel 24.

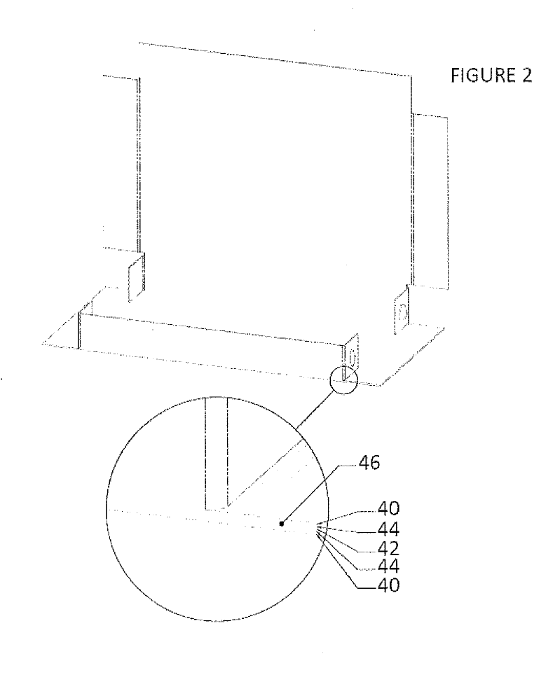

FIG. 2 identifies composite ply 46 consisting of five layers: paperboard base stock 42 joined to tear resistant film 40 on both sides by adhesive layers 44. The paperboard base stock 42 can be made from Solid Bleached Sulphate (SBS), Solid

Unbleached Sulphate (SUS), Clay Coated News (CCN) or other paperboard base stocks commonly used for packaging. Calipers (thickness) can range from 0.006 to 0.040. The laminated paperboard is scored to allow ease in folding.

Film 40 can be blown or cast film made from Linear Low Density Polyethylene (LLDPE), Low Density Polyethylene (LDPE), Medium Density Polyethylene (MDPE), High Density Polyethylene (HDPE), Polypropylene (PP) Polyester (PET), or other blown or cast films which when laminated to the paperboard provide an MD tear resistance of at least 520 and a CD tear resistance of at least 570.

Lamination of the film to paperboard can be accomplished using an extrusion process which applies an adhesive molten resin between the paperboard and films thus bonding the three substrates together, or it can be accomplished using an aqueous adhesive between the paperboard and films.

The above-described configurations provide effective tear resistance by laminating films to both the top side and backside of the paperboard. There is no need to include an additional top coating on the film to achieve appropriate seals.

To evaluate the tamper resistance, we measure tear resistance using TAPPI Test Method T414, Internal Tearing Resistance of Paper (Elmendorf method). In all cases we report tear resistance in units of gram force. One way to evaluate the product is to measure the tear resistance of a single ply. We measured tear resistance in the machine direction (MD) and in the cross direction (CD) of five different single ply SBS sheets, laminated with LLDPE films. Units are in gram force.

Single Ply Tear Resistance
1600 g Pendulum Used

| Sample ID | | 1 | 2 | 3 | 4 | 5 | Average | Std. Dev. |
|---|---|---|---|---|---|---|---|---|
| LLDPE Sample #1 | MD | 744 | 741 | 638 | 666 | 672 | 692 | 48 |
| | CD | 648 | 630 | 662 | 666 | 683 | 658 | 20 |
| LLDPE Sample #2 | MD | 638 | 645 | 618 | 610 | 618 | 626 | 15 |
| | CD | 883 | 683 | 686 | 744 | 784 | 756 | 83 |
| LLDPE Sample #3 | MD | 542 | 522 | 693 | 550 | 659 | 593 | 77 |
| | CD | 707 | 579 | 662 | 609 | 571 | 626 | 58 |

We prefer to use film and paperboard laminations having a single-ply tear resistance of at least 500 in the machine direction and 600 in the cross direction. More preferably the tear resistance should be at least 600 in the machine direction and 700 in the cross direction. Of course the two-ply configuration we describe below will have greater tear resistance.

We measured the tear resistance of a two-ply construct when tearing through the sealed peripheral portion. We measured tear resistance in the machine direction (MD) and in the cross direction (CD) of five different two ply SBS sheets, laminated LLDPE film. Units are in gram force.

Double Ply Tear Resistance
3200 g Pendulum Used

| Sample ID | | 1 | 2 | 3 | 4 | 5 | Average | Std. Dev. |
|---|---|---|---|---|---|---|---|---|
| LLDPE | MD | 1891 | 1878 | 1830 | 2029 | 1824 | 1891 | 83 |
| Sample #1 | CD | 2099 | 1878 | 1884 | 2029 | 1779 | 1934 | 128 |
| LLDPE | MD | 1619 | 1594 | 1798 | 1632 | 2070 | 1743 | 200 |
| Sample #2 | CD | 1872 | 1910 | 1885 | 2230 | 1824 | 1944 | 163 |
| LLDPE | MD | 1754 | 1817 | 1645 | 1709 | 1891 | 1763 | 95 |
| Sample #3 | CD | 1933 | 1837 | 1798 | 1760 | 1856 | 1837 | 65 |

Areas of the carton where flaps or panels are adhered to other flaps or panels exhibit a double ply MD tear resistance of at least 1600, and a CD tear resistance of at least 1700. More preferably the tear resistance under these conditions is at least 1700 in the machine direction and 1900 in the cross direction.

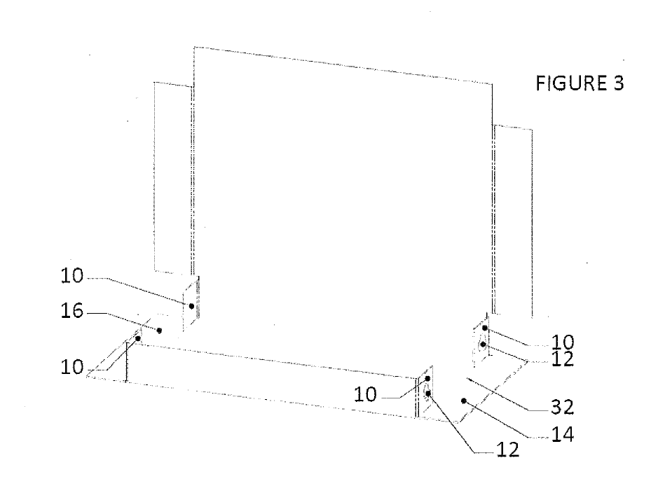

FIG. 3 identifies a tri-sealed carton showing an application of adhesive 12 to four dust flaps 10 after which the bottom closure minor panel 14 and the top closure minor panel 16 are folded upwards to adhere to dust flaps 10. The carton blank is scored 32 to allow for ease in folding.

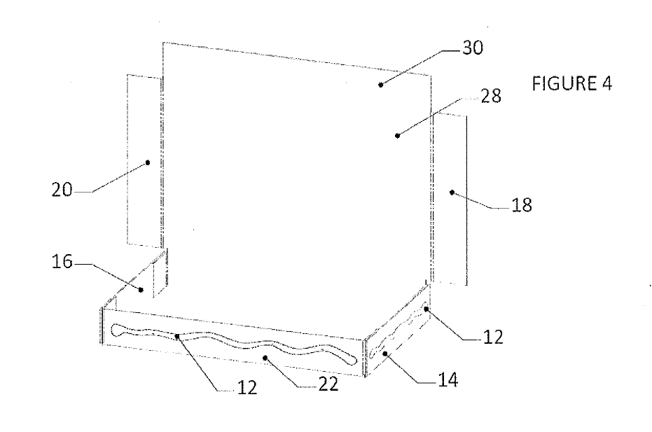

FIG. 4 exhibits a continuation of forming a tri-seal carton whereby additional adhesive 12 is applied to bottom closure minor panel 14, top closure minor panel 16 and glue flap 22. The portion of the carton with areas identified by front panel 28, left side panel 30, bottom closure major panel 18 and top closure major panel 20 are folded downward, after which the bottom closure major panel 18 is sealed to the bottom closure minor panel 14, the top closure major panel 20 is sealed to the top closure minor panel 16 and the left side panel 30 is sealed to the glue flap 22.

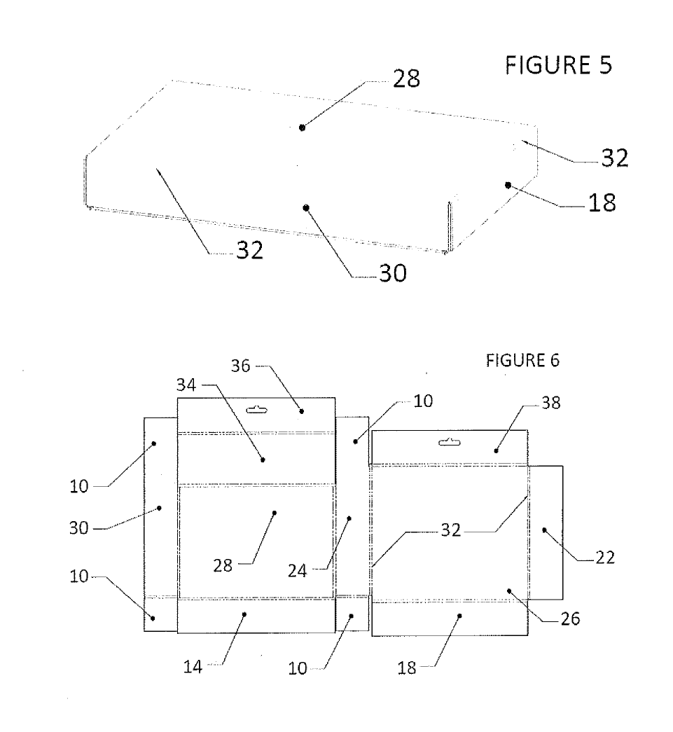

FIG. 5 exhibits a completely formed and sealed tri-seal carton showing the front panel 28, the left side panel 30, the bottom closure major panel 18 and a score 32 which allows for ease of folding.

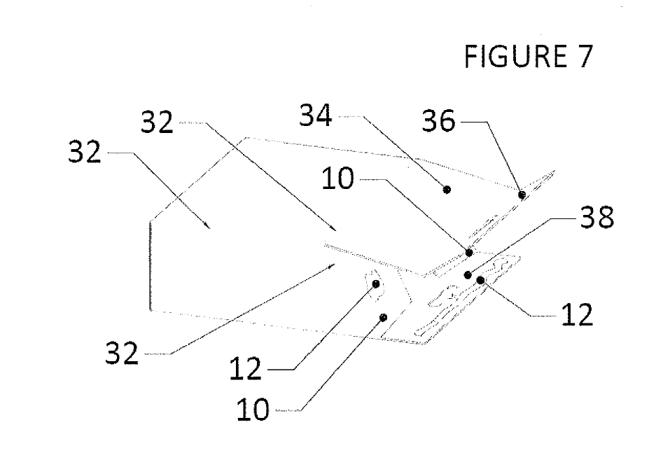

FIG. 6 shows a flat blank design for a tear resistant gabled display folding carton with score lines 32 and die cut areas identified as bottom closure minor panel 14, bottom closure major panel 18, dust flaps 10, a glue flap 22, a rear panel 26, a front panel 28, a left side panel 30 and a right side panel 24, a front gable panel 34, a front hanger tab panel 36, a rear hanger tab panel 38. The top dust flaps 10 are scored at a forty-five degree angle to allow appropriate seals to the front gable panel 34.

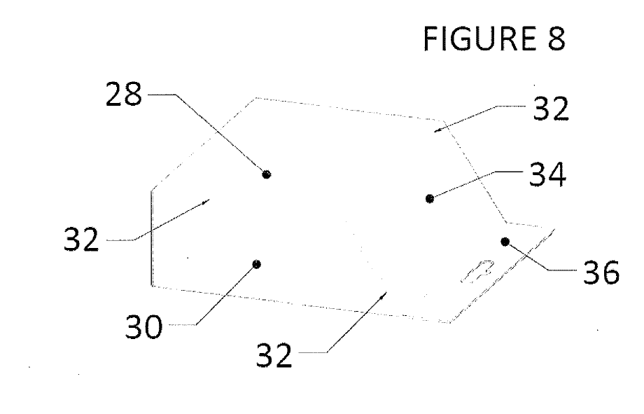

FIG. 7 identifies a gabled display folding carton showing an application of adhesive 12 to upper angled dust flaps 10 and an application of adhesive 12 to the rear hanger tab panel 38, after which the front gable panel 34 and the front hanger tab panel 36 are folded downward to seal to upper dust flaps 10 and rear hanger tab panel 38. What is not shown is a similar gluing process as described in FIGS. 3 and 4, whereby adhesive 12 is applied to the lower dust flaps 10. The bottom closure minor panel 14 is then folded upwards to adhere to the lower dust flaps 10, with a subsequent application of adhesive 12 to the bottom closure minor panel 14, after which the bottom closure major panel 18 is folded downwards to adhere to the glued bottom closure minor panel 14. The carton blank is scored 32 to allow for ease in folding.

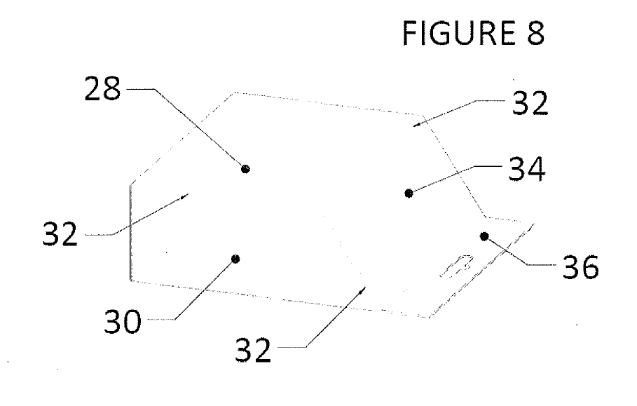

FIG. 8 exhibits a completely formed and sealed gabled display folding carton showing the front panel 28, the right side panel 30, front gable panel 34, the front hanger tab panel 36 and a score 32 which allows for ease of folding.

A number of embodiments of the invention have been described. Nevertheless, it will be understood that various modifications may be made without departing from the spirit and scope of the invention. For example, tear resistant folding cartons commonly referred to as reverse or straight tuck end folding cartons may fall within the scope of the claims. Accordingly, other embodiments are within the scope of the following claims.

What is claimed is:

1. A tear-resistant folding carton comprising a paperboard unit, the unit comprising a paperboard layer, an upper film layer laminated to an upper side of the paperboard layer and a lower film layer laminated to a lower side of the paperboard layer, the carton comprising joining areas in which one portion of the unit overlaps and is joined to a second portion of the unit.

2. The carton of claim 1 in which the unit is folded on score lines.

3. The carton of claim 1 in which the upper film layer, the lower film layer, or both film layers is selected from the group consisting of linear low density polyethylene, low density polyethylene, medium density polyethylene, high density polyethylene, polypropylene and polyethylene terephthalate.

4. The carton of claim 1 in which at least one of the upper film layer and the lower film layer is a non-oriented film.

5. The carton of claim 1 in which each of the upper film layer and the lower is an oriented film, and the orientation of the upper film layer is substantially the same as the orientation of the lower film layer.

6. The carton of claim 1 in which the one portion of the unit is joined to the second portion of the unit by an adhesive that is compatible with the upper film layer and the lower film layer.

7. The carton of claim 1 in which the one portion of the unit is joined to the second portion of the unit by adhesive.

8. The carton of claim 1 in which the one portion of the unit is joined to the second portion of the unit by heat, pressure, infrared, ultrasonic, ultraviolet or radio frequency energy.

9. The carton of claim 1 in which paperboard is Solid Bleached Sulphate (SBS), Solid Unbleached Sulphate (SUS) or Clay Coated News (CCN) paperboard base stock.

10. The carton of claim 1 in which the paperboard base stock is between 0.006 and 0.040 inches thick.

11. The carton of claim 1 in which areas of the carton that are not joining areas exhibit an MD tear resistance of at least 520, and a CD tear resistance of at least 570, measured by TAPPI Test Method T414, Internal Tearing Resistance of Paper and expressed in units of gram force.

12. The carton of claim 1 in which joining areas exhibit an MD tear resistance of at least 1600, and a CD tear resistance of at least 1700.

13. The carton of claim 1 in which joining areas exhibit an MD tear resistance of at least 1700 in the machine direction and a CD tear resistance of at least 1900.

14. A method of producing the carton of claim 1 comprising providing a scored paperboard blank unit, folding the blank unit along score lines to create joining areas and sealing the joining areas.

15. The method of claim 14 in which the joining areas are sealed by adhesive compatible with the upper film and with the lower film.

16. The method of claim 14 in which the joining areas are sealed by applying energy to the lower film layer of the one portion of the blank to the upper film layer of the second portion of the blank.
